(19) United States
(12) Patent Application Publication
(10) Pub. No.: US 2005/0050346 A1
(43) Pub. Date: Mar. 3, 2005

(54) Dynamic comprehensive global enterprise defensive security system

(76) Inventors: Odessa John Felactu, Los Angeles, CA (US); George Odessa Felactu, Redondo Beach, CA (US)

Correspondence Address: KARAMBELAS & ASSOCIATES, 655 DEEP VALLEY DRIVE, SUITE 303, ROLLING HILLS ESTATES, CA, 90274, US

(21) Appl. No.: 10/652,121

(22) Filed: Aug. 28, 2003

(51) Int. Cl. G06F 11/30

(52) U.S. Cl. 713/200

(57) ABSTRACT

A dynamic comprehensive corporate security enterprise defensive system is disclosed which develops and prioritizes a defensive strategy in response to a detected intrusion of corporate security, seals the corporate enterprise while providing continuing oversight to detect anomalies and develops countermeasures employing a dynamic feedback system to preserve the integrity of the seal for the corporate enterprise.

### I. FIELD OF THE INVENTION

This invention relates to corporate security and more specifically to a dynamic, comprehensive enterprise defensive security system which develops and prioritizes a defensive strategy in response to a detected intrusion of corporate security, seals the corporate enterprise employing the system while providing continuing oversight to detect anomalies and developing countermeasures employing a dynamic feedback system to preserve the integrity of the seal for the corporate enterprise.

### II. PRIOR ART

Foreign economic collection of American corporate commercial proprietary assets and industrial espionage are being experienced by American corporate entities on an increasing basis so much so that Section 809 of the Intelligence Authorization Act for fiscal year 1995 requires that the President report to the Congress on foreign industrial espionage targeted against U.S. industry. The Act defines foreign industrial espionage as industrial espionage conducted by a foreign government or by a foreign company with direct assistance of a foreign government against a private U.S. company and aimed at obtaining commercial secrets. It is recognized that espionage and elicit collection activities of information represent attempts by foreign governments and/or industry to acquire classified or non-public information from U.S. firms. Foreign governments and industry are known to collect economic information from U.S. firms through standard business practices such as mergers and acquisitions, strategic alliances and licensing agreements as well as gathering publicly available information. These commonly accepted activities of the business world are largely peripheral to those activities which generate a considerable portion of the technology and economic information obtained by competitors. Although legal methods of obtaining such information include open source collection activities, not limited to review of trade journals or corporate annual reports, market surveys and attending conferences and symposia, in many cases, these types of collection efforts are found to be precursors to elicit collection activities or indicate the intelligence interest of foreign powers or local competitors. For example, attempts by a foreign government's intelligence service to persuade an employee of a U.S. firm to gather information from the firm's library could be the first step in setting up a source that would eventually collect proprietary documents from the same company. Similarly, joint ventures and licensing agreements, although conventional and legal, provide ideal opportunities to gather non-public information from U.S. firms.

As appropriate, the CIA coordinates with other U.S. Government agencies, specifically the FBI, before notifying the U.S. company that it is a specific target of espionage by a foreign government. The government has put many programs into place designed to inform and assist U.S. companies that are actual or potential targets of such foreign government industrial espionage.

The industries that have been the targets in most cases of economic espionage and other collection activities include biotechnology; aerospace; telecommunications, including the technology to build the “information superhighway”; computer software/hardware; advanced transportation and engine technology; advanced materials and coatings, including stealth technology; energy research; defense and armaments technology; manufacturing processes; and semiconductors among many others. It should be noted that proprietary business information that is contained in bid contract activity possessed by customers is aggressively targeted as well as corporate financial and trade data. These industries are of strategic interest to the United States because in many cases they produce classified products for the government, produce dual-use technology used in both the public and private sectors and are responsible for leading edge technologies critical to maintaining U.S. economic security. However, many other U.S. high-tech industrial sectors have been targeted by these foreign entities as well as competitive companies who are vying for an increased piece of market share regardless of the market resorting to intelligence activities as a force multiplier to improve its chances of success.

Although there is no formal mechanism for determining the full qualitative and quantitative scope and impact of the loss of this targeted information, industrial victims have reported the loss of hundreds of millions of dollars, lost jobs, and lost market share. Although these reports are ad hoc and often only after public disclosure of the loss, it is understandable that U.S. industry is otherwise reluctant to publicize occurrences of foreign economic and industrial espionage, which publicity can adversely affect its stock values, customer confidence and ultimately competitiveness and market share.

Many methods are employed to conduct such espionage including traditional espionage methods formerly reserved for collecting national defense information, classic agent recruitment of trusted personnel inside the organization; using unscrupulous inside employees and surveillance of and surreptitious entry into corporate premises to obtain information. Specialized technical operations to obtain information through means of espionage include computer intrusions, telecommunications targeting and intercept, and exploiting private sector encryption weaknesses. These activities have been found to account for the largest portion of economic and industrial information loss by U.S. corporations. The ease of accessing and intercepting corporate telecommunications, particularly international telecommunications, provide a highly vulnerable and lucrative source for anyone interested in obtaining trade secrets or competitive information. Increased usage of these links for bulk computer data transmission and electronic mail provide a cost-effective method for intelligence collectors; for example, foreign intelligence collectors intercept facsimile transmissions through government owned telephone companies which comprise approximately half of all overseas telecommunications. The increasing use of American companies using electronic data interchange as a system of transferring corporate bidding, invoice and pricing data electronically overseas has proved to be a valuable source to foreign governments and corporate intelligence collectors.

Other economic collection methods include tasking foreign students studying in the United States to acquire information, tasking foreign employees of U.S. firms and agencies to do likewise, recruitment of immigrates and ethnic targeting of people in the military and R&D facilities who have access to proprietary and classified U.S. technology; elicitation during international conferences and trade fairs, taking advantage of the huge commercial data base trade and scientific general computer bulletin boards, openly available U.S. government data and corporate publications; and employing clandestine collection of open source materials using false names to access open source data bases. Several countries have also been known to use corporate mergers and acquisitions to acquire technology which, if not prevented, is perfectly legal in nature and allows the foreign company to acquire U.S. origin technologies without spending their own resources on R&D. Foreign companies as well as domestic corporations have been known to hire knowledgeable key employees of competing U.S. firms to do corresponding work for the foreign firm or competitor as the case may be, often to gain inside technical information and use it against its competitor or U.S. firm. In addition, corporate technology agreements, sponsorship of research activities in the United States, hiring information brokers and consultants must receive increased scrutiny in order to prevent industrial espionage.

It is known that the potential for corporate espionage is so vast that in recent years the FBI and CIA jointly have told U.S. business that there is no way that federal agencies could protect American business from itself, or foreign agents.

According to the Canadian security and intelligence service, 72% of businesses which have not taken measures to reduce their vulnerability to industrial espionage and suffered a resulting loss will go out of business within two years. The same survey indicates that 43% of American corporations have had an average of six incidents involving corporate espionage which have resulted in access to its resources of both people and money not normally available to the common hacker or cyber-criminal.

For those involved in these activities the whole purpose of watching, listening and collecting is to provide a mass of data for analysis which when found to be significant and valuable can be sold outright to a client or to a competitor. In addition, it may be used as a bargaining chip to obtain other information either through direct trade, or by leveraging, and in a case where information on employees is involved, it could be leveraged to select people vulnerable to bribes in order to extort further information from employees with vulnerabilities.

In 1997 it was estimated there were fewer than 1,000 people qualified as professional hackers or those capable of creating tools or developing original methods for hacking resulting in few collectors of information who are computer competent to obtain same. Obviously as the number of computer adept hackers increases so does the threat for cyber-espionage.

It is known that collectors armed with bios and names of executives and key employees can search the net for their favorite electronic haunts and then make inquiries of these people posing as an inventor, potential customer, reporter or even a student researching the rising stars of the corporate world.

It is not surprising that human intelligence or the people working in the corporate environment represent a two-edge weapon in securing corporate secrets being both the best protection and the biggest risk. Thus proper training, education and motivation can give people the tools and desire to keep the corporation's secrets intact while conversely appealing to the vanity, greed or human nature of a disenchanted or bored person has always been a tool of traditional spy.

It is known that the Y2K programmers brought in-house to successfully deal with related potential computer problems could also be a source of espionage having immediate access to the reservoir of company information. The unsuspecting high-ranking executive on the road with a laptop computer is loaded with the company's latest and most vital activities is another extreme vulnerability to the integrity of corporate proprietary information. It should be noted that traveling employees are not much safer aboard an airliner since it is known that in some cases the French have been accused of bugging seats in the first class section of their airliners and French hotels frequented by executives. In addition to France, Japan and Israel have been known to conduct active corporate espionage.

Economic prosperity of American business has a significant impact on national security.

Competitive companies may close billion dollar plus technological gaps between them quickly and relatively cheaply with employing industrial espionage. Countries, for example Japan, in the seventies have reputedly over a 10-year period of time taken out about $90 billion worth of technology, suffering only about $9 billion in damage awards for the taking.

In addition to compromising the security of the United States or a U.S. firm, significant economic losses are experienced by these activities. For example, by not preserving corporate intelligence resulting from lack of control of corporate turnover, it has been found that one of six clients replaces its public relations agency each year. Public relations agencies are known to have an employee turnover rate of 32% annually, resulting in an estimated client cost, based on an account of $250,000 in annual billings, of $122,000. Thus it is seen that when clients leave agencies and agencies lose employees, precious organization intelligence is lost and as a result of this turnover the emerging area of knowledge and management which involves the cataloging and maintenance of organizational intelligence has become increasingly important to businesses. Not surprisingly similar losses are and will be experienced in other enterprises of endeavor. For example, it is estimated for a Fortune 500 multinational company having several thousand employees that a reduction of 50% in turnover would yield a savings of a few hundred million dollars just in replacement and disruption of business costs.

“The potential loss to corporate America from the theft of intellectual property alone may amount to more than $300 billion a year according to a recent survey of Fortune 1,000 companies and the 300 fastest growing U.S. companies that was conducted by the American Society for Industrial Security.” This represents a significant increase over the 24 billion to 100 billion which was previously estimated in Ira Winkler's “Corporate Espionage” published in 1997. As previously indicated, these numbers are just estimates because in many cases, understandably, businesses are highly reluctant to admit either committing or being victimized by espionage. Thus, it is seen that industrial espionage experts represent a growing career field for years to come which the United States Government has fought for years and has gone to great expense to minimize or eliminate on a nation vs. nation basis. While various successes have been realized, the failures have been spectacular, for example, the treason of Robert Hanssen, an FBI supervisory special agent, who for over 22 years gave the Soviet Union and Russia vast quantities of documents and computer diskettes filled with national security information of incalculable value; the Ames espionage and the problems associated most recently with the Sandia nuclear labs among others. Although various recommendations have been made as a result of a review of FBI security programs including (1) requiring that FBI security programs be integrated into an office of security that reports to the Director; responsibility for security police be vested in the office of security and managed by security policy board; the office of security should develop a professional security staff through enhanced selection, retention and training programs; the office of security should implement comprehensive security education and awareness programs; the office of security should develop a centralized security violation reporting program; and the office of security should audit security programs. Notwithstanding these recommendations, the report concludes by stating since the Bureau has failed to designate security as a core function, management continues to slight the security program in favor of operational functions and to deny security programs the resources needed to succeed. The key to effective security programs within the FBI is an adequately funded office of security reporting to the Director and responsible for security policy, implementation and training. The report finally concludes by stating “history shows that espionage and security breaches are inevitable. Nonetheless, we can end our review on a guarded note of comfort: it is possible to react rationally to the inevitable, by implementing steps to deter espionage, reduce the time between defection and its detection, and minimize the harm traitors can do.

“We hope that our efforts will contribute to this goal.”

Likewise, corporate espionage within the boundaries of the United States is found to be pervasive and expanding on an ever increasing basis.

Various organizations have instituted and developed enterprise source management to control use of computers, fire walls, including password control, such as for example Semantec Corporation. Others include L'SecureDat and Sword and Shield which provide like services to thwart cyber-attacks on corporate data bases.

### III. OBJECTS OF THE INVENTION

With all the study and investigation regarding both governmental and industrial espionage, the literature is replete with recommendations, identifications of problems, but nowhere is there to be found a comprehensive system directed toward minimizing and eventually substantially eliminating these threats.

It is therefore an object of this invention to provide a corporate enterprise security system devoid of the above-mentioned deficiencies.

A further object of this invention is to provide a comprehensive enterprise security defensive system which ultimately protects corporate proprietary data from outside interrogation.

Yet another object of this invention is to provide a novel enterprise security system which significantly reduces personnel turnover.

Still another object of this invention is to provide a corporate enterprise defensive security system that substantially controls all corporate proprietary assets from public exposure.

Yet still another object of this invention is to provide a corporate enterprise defensive security system that controls all communications access to corporate proprietary repositories.

Still another object of this invention is to provide a comprehensive enterprise defensive security system that develops and prioritizes a defensive system to thwart detected intrusions into corporate proprietary information.

Yet still another object of this invention is to provide a corporate enterprise defensive security system which shields the corporate proprietary data base in all forms from unwanted access and ultimately seals same against such access.

Another object of this invention is to provide a corporate enterprise defensive system which employs continuing oversight of the defensive system as employed.

Yet again another object of this invention is to provide a comprehensive corporate enterprise defensive system which detects anomalies in said system and develops countermeasures to neutralize said anomalies on a continuing basis.

Yet again another object of this invention is to provide a comprehensive enterprise security defensive system which prevents a departing employee from creating a rostering effect.

Again, another object of this invention is to provide a comprehensive enterprise defensive system which results in predictable corporate quality control, customer satisfaction and production efficiencies.

### IV. SUMMARY OF THE INVENTION

These and other objects of the instant invention are accomplished, generally speaking, by providing a comprehensive corporate enterprise defensive security system which includes developing, prioritizing and employing a defensive strategy to thwart detected intrusion; providing a process to seal a corporate enterprise against such intrusions; providing continuing oversight of said process; detecting anomalies in said process; developing countermeasures to neutralize said anomalies and preserving the integrity of the seal so constructed to prevent further intrusions. Thus there is provided a system which in a general sense results in sealing off the corporation or shutting out the public from access to a corporate entity with the exception of need to know, or business necessary access through controlled channels. This comprehensive enterprise security defensive system as offered commercially by The Odessa Group, hereinafter referred to as Molon Lave™ system, is seen to be an effective deterrent to the reported 13,342 executive recruiters in the United States who routinely raid, poach and recruit key executives in corporate America as reported in the July 2003 Kennedy Information. Molon Lave™ system is also a deterrent to former employees and especially key executives rostering an organization or causing other employees to leave as they leave or shortly after they leave, thus resulting in the loss of valuable corporate proprietary information and capability. This system is also found to be effective in countering competitors seeking proprietary data; limiting access to corporate internal employment departments and their respective global recruiting staffs; access to consultants retained by the corporation as well as internal informants and sources, contract and part-time employees.

Molon Lave™ system is a comprehensive enterprise defensive security system which thwarts all forms of threats to the internal integrity of human capital, intellectual property and trade secrets. Molon Lave™ system provides comprehensive procedures and mechanics necessary in mitigating an organization's exposure by first developing an appropriate shield to such exposure and ultimately sealing the organization at the agreed upon level of access. In its training phase Molon Lave™ system will develop best practices to provide optimal document control, information security and personnel security. The Molon Lave™ system will effect a cultural change that will transform a porous organization into both a defensive and offensive enterprise with the ability to protect itself and its employees.

Corporate turnover at all levels, but most significantly at the executive levels, will be substantially reduced, preserving the company's most valuable assets, its human capital. This implementation of Molon Lave™ system will is result in minimizing and/or eliminating loss of productivity, loss of intellectual property, loss of employee relationships, for example with vendors, suppliers, etc.; loss of customers; inability to execute business plans or achieve goals; loss of strategy execution; loss of critical trade secrets to competitors; loss of stockholder value; inability to pursue growth opportunities, and appreciation in morale.

In order to demonstrate the pervasive nature of unwarranted and unauthorized public access to corporate assets as described above, the inventor with great facility profiles a major corporation through its information system, executive office, human resources and operator telephonically. In a free and competitive society the culture of most major corporations is found to be helpful, gracious and accommodating, consequently offering corporate information freely without questioning authority or the identity of the requester.

Merely relating serious penetrations into corporate proprietary information and suggesting that appropriate training be put into place including certain filtering or channeling procedures for incoming calls (and indicating that a method of sealing the enterprise be developed in addition to developing a test and audit system) resulted in immediate non-sustainable savings by a corporation without employing the full strength and power of Molon Lave™ system. Immediate and non-sustainable improvement and retention of intellectual property critical to the company's existing programs and future was realized; unwanted interrogations directed to recruiting employees was curtailed, employee turnover rate was reduced dramatically, all of which return an amazing savings on a nonsustainable basis of approximately $16 million in operating costs in a very short period of time. This savings, although significant, represents but a fraction of sustainable savings that may be realized by a corporate entity when employing Molon Lave™ system.

Since even after employing its best efforts a corporation's proprietary assets are open to access, Molon Lave™ system only optionally includes an intrusion or detection phase to assess the current state of security and access to company proprietary, human capital, intellectual property, trade secrets and the like as recited above.

The first step employed in the Molon Lave™ system is to develop and prioritize a defense to all intrusions into the corporate environment seeking to avail themselves of corporate assets.

### DEVELOPING AND PRIORITIZING DEFENSIVE SYSTEMS

Molon Lave™ system is a program designed to frustrate, confuse and deny all access to all parties having illegitimate motives, agendas and purposes against your enterprise. It provides all employees with methods, mechanics and training to transform a vulnerable unprepared corporate liability into a combat prepared asset for the corporation. Molon Lave™ system provides an array of defensive and evasive tools, procedures and practices which, when implemented in toto, result in a defense capable of countering external threats. It offers enterprise procedures for systems that reject illegitimate inquiries while promptly and efficiently assisting authorized requests. Molon Lave™ system employs a multi-functional, multi-faceted approach to restricting access, controlling and denying same within departments, sites, operators, and administrators of the corporate entity. Every issue is consequently examined employing the Molon Lave™ system to the extent it addresses personal security, personnel privacy, policy modification and policies addressing personal security, information security and documentation security.

Molon Lave™ system ultimately seeks to restrict, control and deny access. Access restriction is implemented at least by function, department, organizational level, officers, key core competencies, and critical personnel. An enterprise's policy to preserve and defend intellectual property and trade secrets of the client enterprise is duly implemented. Training is initiated to educate all employees regarding personnel, document and information security and appropriate modifications to access by Internet, fax and mail are instituted.

Policies are developed and instituted to suit the enterprise's specific needs which establish, restrict, control and qualify access to business critical information. The focus is directed to a number of key areas where access to corporate assets may be obtained including, but not limited to: operators role; administrators; voicemail/cell phones; corporate business cards; corporate websites; corporate articles and trade journals; corporate participation in industry conferences; corporate listings in phone directories; corporate organization charts; and general rules for communications of the organization.

Since effectiveness of the defensive chain around access to a corporate enterprise's valuable information is only as good as its weakest link, each of these aspects is given utmost scrutiny. For example, telephone operators are instructed to: not offer last names of any employees, never verify or provide the title of employees, never connect the outside to an employee unless full name is given, never look up names based on a partial listing, not connect to a party where multiple listings exist unless the middle initial is known by the caller; identify and delist critical core employees from the switchboard; transfer calls to an administrator and never to requested employee; not provide phone numbers to alternate site or reception areas; never discuss the number of sites on this campus or any other campus; and never transfer to IT.

With regard to administrators, callers are to be qualified based on questions and attention is to be given to any possible deceptive technique employed by the caller. Calls are never to be transferred directly to executives and messages are not to be taken or left for any consultant. All calls for consultants are to be transferred to the appropriate hot gate or controlled communication mechanism instituted by employing the Molon Lave™ system.

Outside parties are never to be transferred into voicemail when the party is unknown. All callers names are to be taken and in the case of a company employee, are to be verified with ID and questioned as to nature of the call to the executive involved. No information is to be given to outside callers with regard to an executive's title, responsibilities, organization or direct reports. Although proper business decorum is to be recognized and employed, politeness and courtesy are not the order of the day when calls are received from executive recruiters. These must be handled in a strictly business manner by obtaining a name, phone number and position to be filled and immediately forwarded to Human Resources.

When information is sought through either messages left through voicemail or through cell phones, the corporate employee is not to leave his or her last name, title or phone number. Names of other employees in the absence of those called are not to be left or eluded to or mentioned and generally an enterprise-wide policy to receive and process messages must be implemented which suits the needs of the specific enterprise.

Business cards of an enterprise should not list title, direct dial number, email or cell phone number, but only a corporate operator number should be listed so that proper control may be maintained.

Proper implementation of websites requires that all information be deleted providing both first and last names of employees, officers, street addresses, location of plant sites, sales and marketing vendors, advertisements, banks, investment banking and trade show attendees. Organizational charts are to be jealously guarded and strictly controlled for access to those with a need to know. Care should be taken when the corporation publishes articles in trade journals with regard to employees names, titles or any information on addresses of corporate locations.

If vulnerabilities are found, with regard to illegitimate access during industry conferences, the appropriate Molon Lave™ policies must be employed, for example, the presenter will have a classified status for approximately six months after the conference so as not to be identified or reachable by a calling company.

Careful control of corporate phone directories must be initiated so that they are numbered and distributed on a limited basis with the expired copies returned and destroyed. Appropriate markings must appear on these directories with warnings not to loan, share, copy or remove from corporate premises and they must be marked “Confidential Proprietary” and in some cases “Company Secret”.

All organization charts should be strictly controlled and accessed by a select few and a policy implemented through Human Resources to meet the special needs of the enterprise involved to define access and control from creation to distribution of such organization charts. Appropriate legends should be affixed to these charts that they are not to be copied or faxed and all names and phone numbers should be deleted from all such entries in these charts.

All of these precautions and others which are suitable and appropriate must be exercised in the daily course of business of the organization. Particular emphasis must be placed upon communications to the outside, including retirees, access to sensitive information by operators, auditors, accounts payable, accounts receivable, the library, if any, quality control, if any, operations, sales, and engineering. Access through external Internet to corporate information is to be restricted and controlled through Human Resources, customer service and purchasing where appropriate. Access to sales, marketing, engineering, and the executive team is to receive a high level of scrutiny with regard to control and access.

With regard to other external points of access, particular attention should be paid to the control of retained search firms, employment agencies, subcontract/contract recruiters, temporary/consultant help, and retirees. Suitable training and policies are implemented directed to the specific requirements of the enterprise involved with regard to these points of access. In addition, careful attention is directed to employee departures. All such departures are carefully documented and exit interviews conducted to cover corporate policy with regard to proprietary information and other obligations of the departing employee pursuant to a properly executed employment agreement.

### SEALING THE ENTERPRISE

The sealing starts after the prioritization and development of the defensive system is in place, which comprises training that occurs at every level enterprise-wide, including every individual from the top corporate executive down to the janitors. Group training is employed using a combination of interrogating a website, e.g., watching the interrogation or the training over a monitor and in some cases at the upper levels will be employed on a personal basis or a combination of the two. After a thorough training program at every level, the system that has been so prioritized and developed and sealed will be tested. Expert interrogators will make every effort to invade and intrude upon or penetrate the company's corporate shield or defense mechanisms to capture any level of information from very narrow to very broad through all possible targets in the organization. This phase is conducted on a random basis without notice, from the janitorial level to the top corporate executives and the board of directors. When suitable, depending on the size of the organization, the testing will be done sequentially with the following priority: the board of directors, the top executive officers, the leadership teams, direct supervisors and managers at all sites and perhaps a level of key employees at each of the divisions, including former employees and retirees. It has been found that retirees are a particularly helpful source of information and therefore constitute an ominous threat to the protection of corporate information.

### DETECTING ANOMALIES

The detection system may include any suitable method of detecting such intrusions into the corporate asset base. For example, typically a third party research company may be employed that has expertise and people skilled with the deceptive practices that are known to provide access. Molon Lave™ team will retain the two or three best of those companies, give them a specific assignment chartered to access, e.g. an engineering organization within this protected company, top core executives and another department. The Molon Lave™ system will, where appropriate for example, provide three to five days of billing to accomplish the task and will require documentation for the process employed, including specifics such as who was spoken to, what was said and how the process was conducted. In conducting this business and doing future research these outside personnel will not be informed of the specific purpose and goal to be achieved. The resulting documentation will be employed to verify the validity and robustness of the Molon Lave™ plan implemented modified by corrective procedures. This testing process is sampled on a continuing basis until a seal results having deficiencies at less than 5%. This is done on a continuing basis so that, for example, different organizations are monitored quarterly for a year. After the testing and feedback of the system is accomplished, employing in some cases countermeasures, the Molon Lave™ team will take on the guardianship of the whole program to train others, for example, subcontractors. Certification of any company, supplier or subcontractor to the enterprise will be obtained assuring compliance with instituted Molon Lave™ policies and procedures. Accordingly, e.g. temporary help, subcontractors or consultants will be required to be website trained and subsequently agree to abide by Molon Lave™ policies and procedures, executing the appropriate non-disclosure agreement.

### COUNTERMEASURES

Any suitable method of developing and instituting countermeasures may be employed in the system of the instant invention. These are typically instituted after sealing the organization and detecting anomalies. Typically the detected anomalies are countered by effectively revising the intrusive problem so that the intruder becomes the target. This detection will be effected by allowing in two or three access points, gated entry (controlled) so that incoming calls comprising heavy traffic, e.g. in sales, marketing and engineering, will be monitored. With the appropriate Molon Lave™ system training, participants are incentivized to inform a countermeasure pool of potential intrusions. For example, a call from an employment agency is reported to Molon Lave™ staff. The significance of the information is assessed by the Molon Lave™ staff. When a legally actionable event is detected, suit is brought and the pool participants who provided the information are rewarded. Once a company is identified, that company's engineering organization, marketing organization, and sales organization are profiled as well as its top executives and this information is then made available to other recruiting firms, among others, exposing the intruding or attacking company to intrusions of like kind. Alternatively, after identification of an intruding company, notice will be provided to same before commencement of countermeasures is found to be necessary. All information that is obtained is information the intruding company provided freely and consequently may be employed as the enterprise chooses including retaliating countermeasures. Such information is freely available as recited above and is easily obtained employing routine telephonic contacts in addition to other points of access as described above.

### CONTINUING OVERSIGHT

Continuing oversight of the system (monitoring the process) so employed and developed is provided, including the detection of anomalies in the process and the developed countermeasures to neutralize these anomalies, providing the integrity of the seal resulting in the shielding of corporate assets from the public.

### V. BRIEF DESCRIPTION OF THE DRAWINGS

The inventive structural component of the instant invention may be more fully understood with reference to the accompanying drawings of which:

FIG. 1 is a diagrammatic flow chart of the Molon Lave™ system.

### VI. DETAILED DESCRIPTION OF THE DRAWINGS

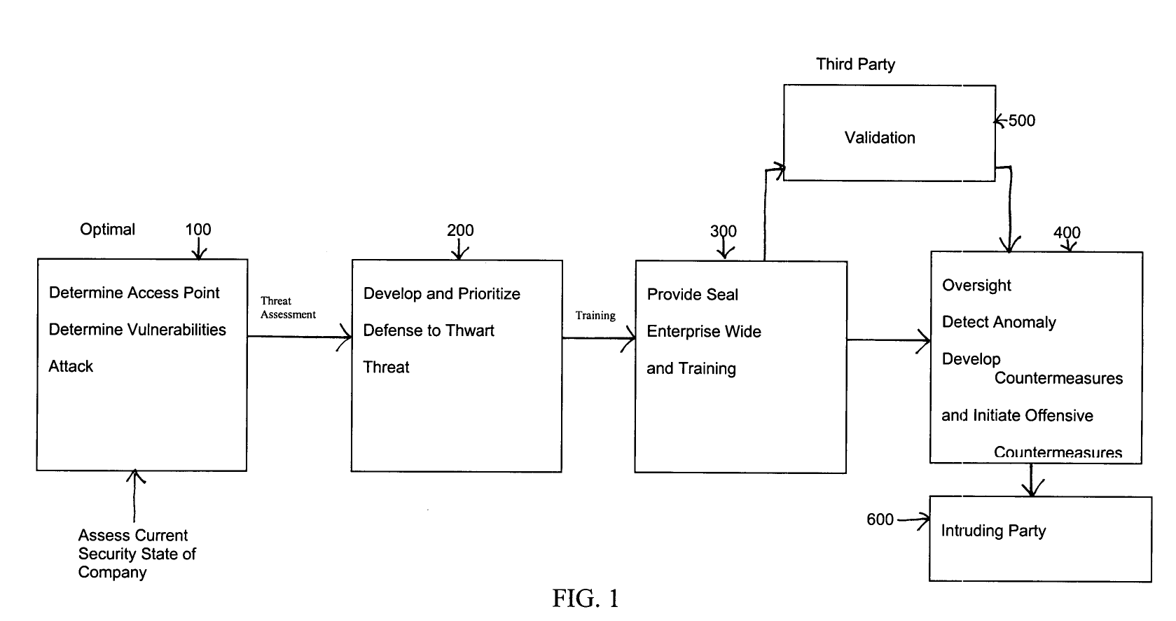

In FIG. 1 there is seen the optional assessment of the state of security of the enterprise designated as 100. As hereinabove recited, typically, based on experience, this threat in its various forms is assumed so that this function is considered to be optional. The threat assessment either assumed or detected optionally is transferred to 200 where a counter to the threat so assessed is developed and prioritized to thwart same. Training is provided after the counter is developed to provide a seal to the enterprise 300 which involves further and continuing training. The sealed enterprise 300 is continuously interrogated and tested by oversight function 400 which detects anomalies and develops countermeasures in addition to validation function 500 employed where third parties are employed to independently interrogate and validate the seal. If appropriate the countermeasures developed in function 400 are initiated and transmitted to the intruding party 600.

It is to be understood that each step as outlined above in the Molon Lave™ system, resulting in a dynamic comprehensive enterprise defensive security system, is customized by a trained Molon Lave™ team to meet the specific requirements of each client application. Likewise training by the skilled Molon Lave™ team which may be conducted at all levels in the enterprise is customized to meet the specific requirements of the client application and is employed on a continuing basis with oversight by the Molon Lave™ team indefinitely or for a finite period after which the transfer of such responsibility is effected to the enterprise providing periodic oversight of the sealed system.

While the present invention has been particularly described with respect to a preferred sequence of process steps in the system of the instant invention, it will be understood that the invention is not limited to the process steps, the sequence, or the final flow depicted in the drawing or as described in the specification. On the contrary, it is intended to cover all alternatives, modifications, and equivalents as may be included within the spirit and scope of the invention defined by the appended claims.

In addition, other methods and/or devices may be employed in the system of the instant invention as claimed with similar results. In particular, the scope of the invention is intended to include, for example, those devices and methods employing automated devices to identify, qualify, admit or reject access depending on business need including voice recognition, iris recognition for physical entry, fingerprint recognition devices and automatic initiation of countermeasures.

1. A dynamic comprehensive enterprise security defensive system including real-time feedback comprising:
developing and prioritizing a defensive system to thwart outside intrusions to corporate assets;
providing a process to seal the enterprise against said intrusions;
providing continuous oversight of said process;
detecting anomalies in said process; and
developing countermeasures to neutralize said anomalies.

2. The system as defined in claim 1 wherein real-time feedback is provided employing continuing oversight of the system.

3. The system as defined in claim 1 wherein the process to seal is validated by employing a team other than a system implementing team.

4. The system as defined in claim 1 wherein said developing and prioritizing step comprises establishing, restricting, controlling and qualifying access to business critical information of the enterprise.

5. The system as defined in claim 1 wherein the process to seal comprises providing extensive training to counter intrusions at all staffing levels of the enterprise.

6. The system as defined in claim 1 wherein said continuous oversight comprises providing comprehensive sampling of the seal and feedback to the system.

7. The system as defined in claim 1 wherein said detecting anomalies comprises sampling and testing for anomalies on a continuing basis.

8. The system as defined in claim 1 wherein said developing countermeasures comprises detecting the anomaly and employing said anomaly against a party instituting said outside intrusions.
